(19) United States
(12) Patent Application Publication
(10) Pub. No.: US 2007/0187943 A1
(43) Pub. Date: Aug. 16, 2007

(54) Printed publication with separable sections

(75) Inventors: Virginia Lee Parisi, Pickering (CA); Justin Joseph Parisi, Pickering (CA)

Correspondence Address: DENNISON ASSOCIATES, 133 RICHMOND STREET WEST, SUITE 301, TORONTO, ON, M5H 2L7, US

(73) Assignee: 1331824 Ontario Ltd., Ajax (CA)

(21) Appl. No.: 11/704,282

(22) Filed: Feb. 9, 2007

(30) Foreign Application Priority Data
Feb. 14, 2006 (CA) 2536712

(51) Int. Cl. B42D 1/00

(52) U.S. Cl. 281/38

(57) ABSTRACT

A printed publication is produced having at least two sections which are separable one from the other by tearing along a weakened region along the spine. Each section preferably has pages produced by a web based printing system with edges thereof secured to the adhesive binding. Interior covers are provided between adjacent sections with a removable insert intermediate the interior covers. Removal of the insert assist in appropriate tearing of the publication between sections to physically separate one section from the other. A method of manufacture of this publication is also disclosed.

### FIELD OF THE INVENTION

The present application relates to binding of printed publications and in particular, relates to the production and binding of printed publications that can be physically separated into at least two distinct parts.

### BACKGROUND OF THE INVENTION

Many products or catalogues sold in a particular market, require printed support material in at least two different languages. In the United States, many products are offered with the support material in at least three languages. Manuals for many products, and in particular, electronic products, are quite lengthy, particularly if a single printing is to be used and the various language versions are all provided in the single printed product. Such a multi-language manual is also awkward due to its considerable size.

From a manufacturing point of view it is desirable to produce a single manual for a product with the various language alternatives provided therein. It is less desirable to print different independent versions of the manual and then combine these different versions with the package product. From a user's point of view, it is desirable to have a single language version of the manual primarily to reduce the size thereof.

The same single printing advantages apply with respect to product catalogues where the end user will have a preference for one language over the other.

For large volume print orders, it is desirable to print the pages on a web based system used for large volumes and subsequently bind the pages in a suitable manner.

The present invention provides an arrangement for producing a publication such as a manual or product category which is divided into at least two sections with interior covers provided between these sections. The publication is separable one section from the other by tearing thereof by the end user to produce two distinct sections with suitable quality front and back covers.

### SUMMARY OF THE INVENTION

A publication according to the present invention is divided into at least two sections where each section comprises a first cover, a series of pages, and a second cover. The publication between opposed covers of adjacent sections includes a weakening member to assist in separation and removal of sections one from the other. The series of pages, the covers and the weakening members are adhesively secured on a spine portion of the publication by a suitable adhesive where the adhesive securement of any weakening member to the spine is of reduced strength relative to adhesive securement of the covers to the spine. This produces a tear region along the spine between adjacent sections.

According to an aspect of the invention, the publication has two sections.

In a further aspect of the invention the publication has at least three sections.

In a further aspect of the invention, each weakening member is a removable insert.

In yet a further aspect of the invention, each weakening member is of a material similar to the covers. Preferably, the covers are of a heavier paper stock relative to the series of papers.

In a different aspect of the invention, a series of pages are preferably produced by web based printing.

In a further aspect of the invention, a series of papers each including a non-notched edge adhesively secured to the spine.

In a further aspect of the invention, a series of pages each include a generally straight adhesive receiving edge secured to the spine.

A method for the manufacture of a printed publication according to the present invention is used for producing a publication having at least two sections capable of being physically separated one from the other with the sections forming pairs of adjacent sections. The method comprises the steps of assembling a series of signatures in combination with at least one group of two interior covers and a weakening member therebetween. Each group is located between and separates a pair of adjacent sections aligning the signatures and the interior covers and weakening member by cutting at least the signatures along a cut edge to form cut pages and aligning the cut edge with a binding edge of the interior covers and weakening members. A tearable glue is applied to the aligned cut edge of the pages and the binding edge of the interior covers and weakening member, and applying and adhesively securing an outer cover about the sections and across the cut edge and the binding edge.

In a preferred aspect of the invention, the method includes providing at least one tear region in the outer cover where each tear region is located between adjacent sections and aligned with the weakening member located between the interior covers.

In yet a further aspect of the invention, each tear region is a perforation line provided in the outer cover prior to securement of the outer cover to the publication.

In a different aspect of the method, the interior covers are paper stock similar to the paper stock of the outer cover.

In a different aspect of the invention, the signatures are produced by web printing on a coated paper web.

In yet a further aspect of the invention, the method includes using a hot melt adhesive as the adhesive for securing of the pages interior covers and the outer cover.

In a further aspect of the invention the method includes trimming the publication along edges thereof to form a finished publication.

### BRIEF DESCRIPTION OF THE DRAWINGS

Preferred embodiments of the invention are shown in the drawings, wherein:

FIG. 1 is a schematic view of the method of manufacture of the printed publication;

FIG. 2 is a partial perspective view showing the separation of two sections of the publication;

FIG. 3 is a perspective view showing partial separation of the two sections of a publication;

FIG. 4 is a view similar to FIGS. 2 and 3 showing a publication with three separable sections;

FIG. 5 is an end view showing a series of pages and a folded insert between two sections which will form two interior covers and an intermediate weakening member;

FIG. 6 is a perspective view of the insert member of FIG. 5;

FIG. 7 is an end view through a printed publication having two interior covers and two weakening members;

FIG. 8 is an end view of a publication where two the two weakening members are being removed;

FIG. 9 is a partial perspective view showing a folded insert that forms the two interior covers and two weakening members;

FIG. 10 is an end view through a publication showing the adhesive securement of the cover of the pages and the interior covers;

FIG. 11 is a partial perspective view of a partially finished publication with two interior covers and a weakening member;

FIG. 12 is a partial perspective view showing a publication produced by a different process where the signatures are not cut but are merely notched and glued to the binder;

FIG. 13 is a partial cut away of this alternate publication; and

FIG. 14 is an end view of this alternate publication.

### DETAILED DESCRIPTION OF THE PREFERRED EMBODIMENTS

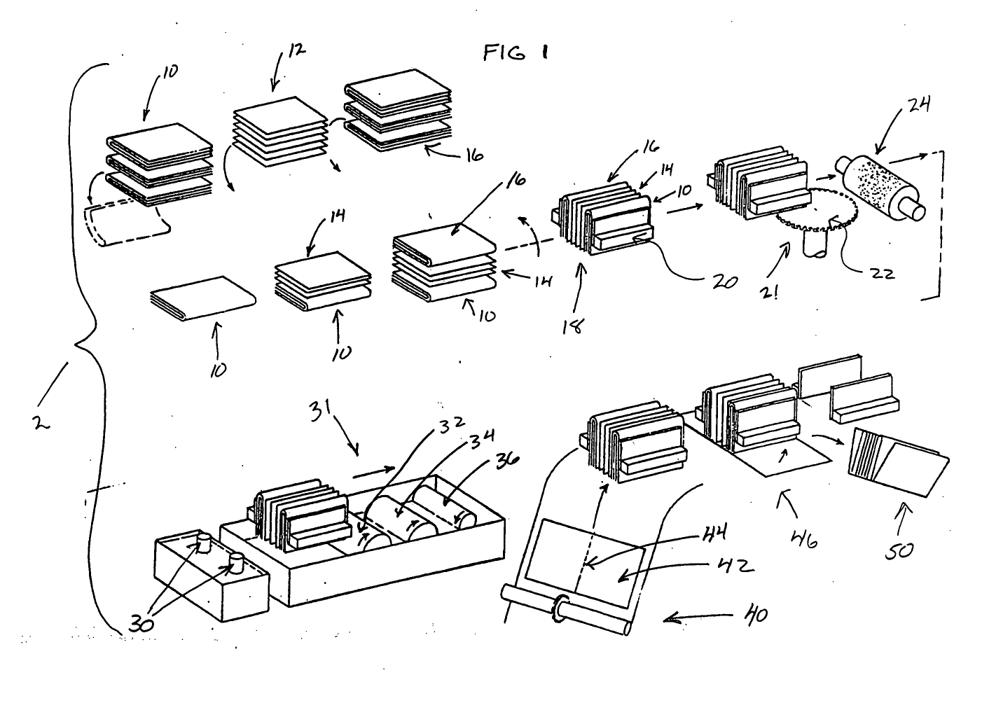

FIG. 1 illustrates a binding operation 2 that is a modified process that includes certain automated steps common an automated binding system sometimes referred to as a perfect binding system. This binding system can generally be used in association with signatures produced using a sheet fed printer, however, the process as indicated in FIG. 1 is illustrated for use in association with signatures 10 and 16 produced by web printing. Web printing is commonly used for high print production volumes.

The signatures 10, the interior covers 12 and the signatures 16 shown at the upper left hand corner of FIG. 1 are representative of various stations on the perfect printing system. An initial signature 10 is fed to a conveyor system and is then moved to a second position where the interior covers 14 are shown to be added. This group is then advanced a further station where the signatures 16 are added. As can be appreciated, additional signatures can be added to increase the number of pages in a particular section.

For example, there may be several stations which load initial signatures 10 followed by a station which inserts the interior covers 14 followed by a number of stations which insert the additional signatures 16. Once the interior pages of the publication have been generally assembled as shown as 18, they are rotated 90 degrees and provided to a cutting station 21. The high speed rotary cutter 22 cuts the bottom edge of the signature and the interior covers and then passes these cut edges over a roughening member 24. This roughening member 24 serves to improve the characteristics on the edges of the signatures 10 and 16 to improve adhesion of the pages at the spine to the adhesive and to the outer cover as will be subsequently described.

In web based printing, the signatures 10 and 16 are often coated pages to improve the quality thereof while maintaining a low cost. These types of signatures can also have fillers in them which do not assist the adhesion characteristics. For example, clay is also added as a filler and is detrimental with respect to the adhesion characteristics. In contrast, the interior covers 12 are of a heavier weight paper and are typically of a better quality. The edges of the interior covers 12 are also roughened but these covers have better adhesion characteristics than the individual signatures 10 and 16.

After being processed by the roughening member 24, the assembled publication passes through the gluing station 31. Initial vertical glue rollers 30 apply a small amount of adhesive on either side of the assembled publication. This glue will eventually secure the side edges of the outer cover 42 to the exposed first and last pages of the publication. The assembled publication passes over a first glue roller 32 which is designed to provide a degree of penetration of the glue along and into the edge of the cut publication. The second glue roller 34 is designed to apply a layer of adhesive along this cut edge and counter roller 36 serves to level the adhesive. Once the adhesive has been applied to either side of the edge of the publication, it is advanced from the gluing station and brought into alignment with the outer cover 42 which is secured to the adhesive as generally indicated at station 46. The outer cover is effectively pressed against this edge and is also partially wrapped around the edge of the publication to pick up the glue applied by the rollers 30.

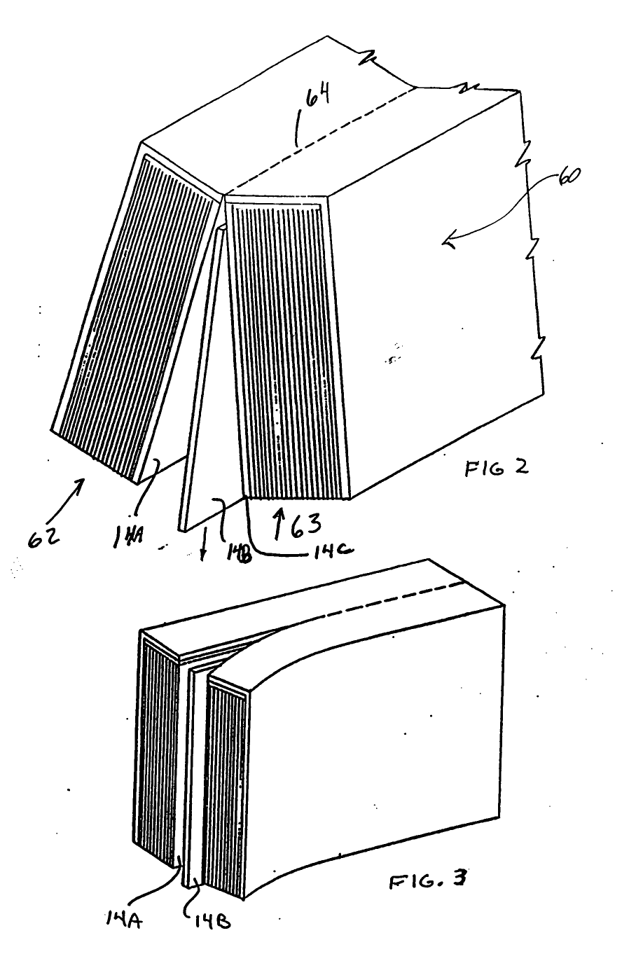

The publication 50 discharged from the gluing station will still require a trimming operation with respect to the two side edges as well as the edge opposite the spine of the publication. As can be appreciated from a review of FIG. 1, the signatures 10 and 16 which make up the individual sections of the publication are cut along their bottom edge and thus will form individual pages adhesively secured to the spine as generally shown in FIG. 2. The publication 60 has been finished and has a first section 62 and a second section 63 with the 3 interior cover members 14A, 14B and 14C being centered between these two sections, thus each section 62 and 63 includes an effective outer cover as well as what will become a rear cover formed by the interior covers 14A and 14C. The center interior cover 14B is in fact a removable weakening insert which improves the ability to separate the sections one from the other along the perforation line 64. By removing the weakening insert 14B, the publication is easily torn as indicated in FIG. 2 to allow the separation of the sections one from the other along the perforation line 64 as indicated in FIG. 3.

It has been found that the two interior covers 14A and 14C with the weakening insert 14B therebetween, provides an arrangement where the covers 14A and 14C are adhesively secured to the publication in an effective manner whereas the removable insert 14B has relatively poor adhesion to the spine. Removing of the removable insert member and the subsequent tearing along the perforation line 64 which is generally in line with this removable insert allows effective separation separation of these sections.

In FIG. 4 it can be seen that a publication is produced having three sections 62, 63 and 65 with adjacent sections being separated by two interior covers and associated removable insert. The removable inserts in this case identified as 14B and 14D are being removed to allow separation of the publication into the three sections. In this case, the spine 68 of the publication, and in particular the outer cover 42, includes two perforation lines 64A and 64B to promote separation of the individual sections.

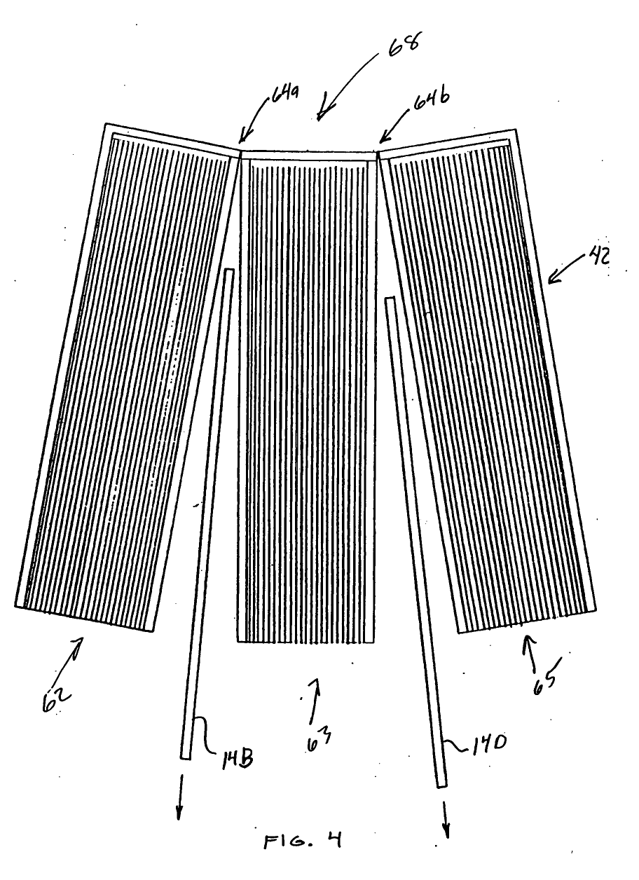

In FIG. 5 a folded interior cover insert 72 is shown which allows one station of the perfect binder to feed the substrate which will form the interior covers and weakening insert. This allows more efficient use of the stations of the binder system. This folded substrate is cut along cut lines 74 and 76 to form the two covers and removable insert between adjacent sections.

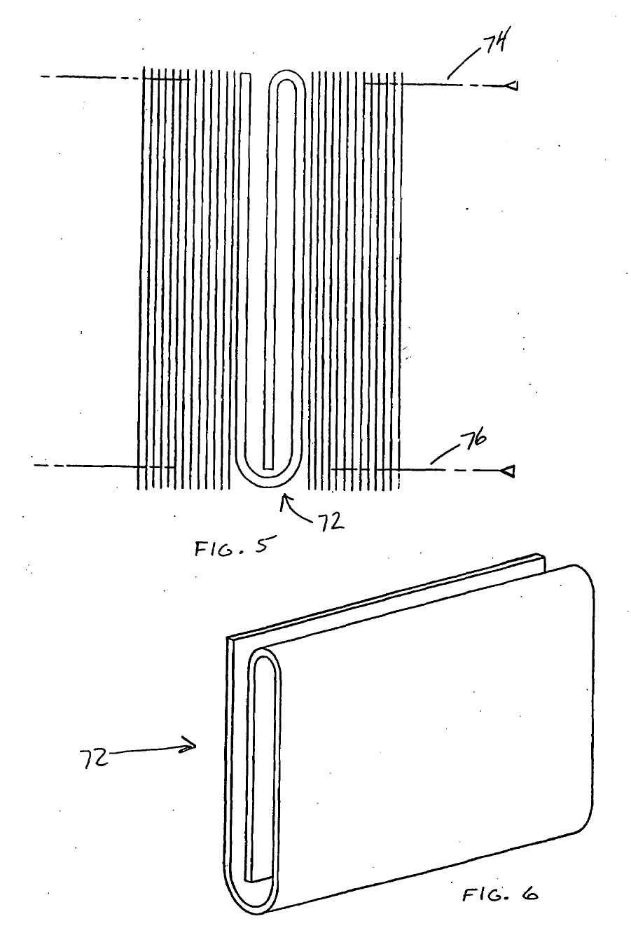

FIGS. 7, 8 and 9 show a different insert 80 which will form two interior covers and two removable inserts as shown in FIG. 4. In this case, the center two removable inserts identified as 81 and 83 are removed while leaving the two covers 85 and 87 strongly secured to their respective sections. The outer cover of this publication shown as 42 will include the perforation line 64 aligned with the two removable inserts. These removable inserts provide a weakening in the spine 68 of the publication and allows the separation of the two sections along a tear region.

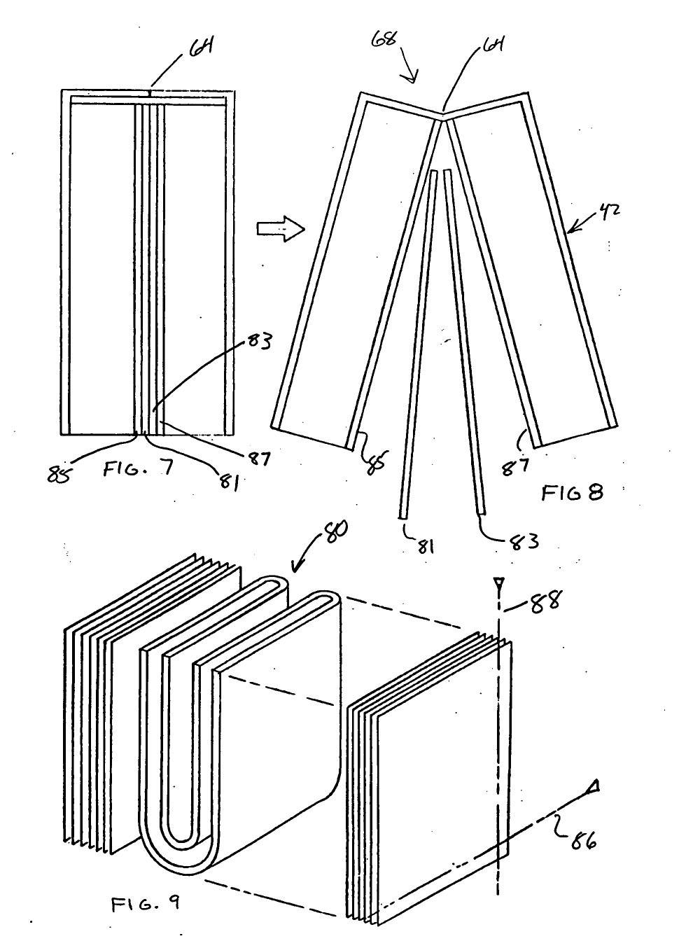

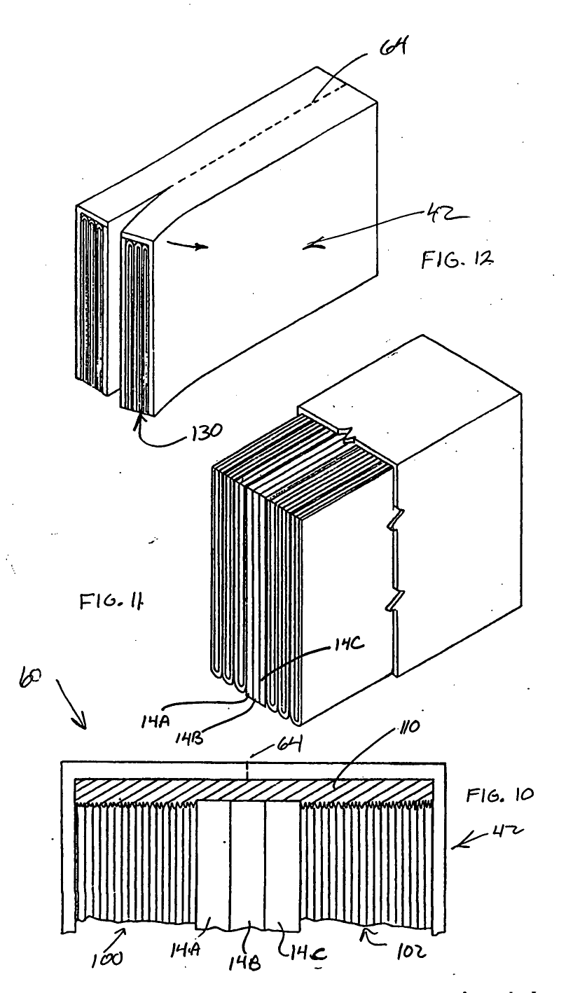

FIG. 9 shows the particular insert 80 which has a single fold insert that is subsequently cut along lines 86 and 88 to form the separate interior covers and removable inserts.

FIG. 10 shows the publication 60 where the pages 100 form one section and the pages 102 form a second section. These sections are separated by the interior covers 14A, 14C and the removable insert 14B. As previously described, the removable insert 14B is basically a sacrificial insert which is removed and provides a weakening of the spine adjacent the perforated line 64 provided in the outer cover 42. The individual pages 100 and 102 have had the cut edges roughened to provide positive securement with the flexible tearable hot melt adhesive indicated as 110. This layer of adhesive serves to secure the individual pages, secure the covers 14A, 14C and removable insert 14B, as well as secure the outer cover 42. It has been found by providing the two interior covers 14A and 14C with intermediate removable insert 14B that there is relatively strong securement of cover 14A to the adhesive layer 110 as well as strong securement of the cover 14C. It is believed that the edge adjacent the paper provides stronger securement and there is some grabbing on the edge of these interior covers that assist in the securement. Details are shown in FIG. 10 where the adhesive 110 engages the edges of the covers 14A and 14C adjacent the pages. In contrast, removable insert 14B is essentially secured by adhesive on the end of this insert. As can be appreciated, the perforation line 64 in combination with the removable insert only secured at its end defines a tear region for the adhesive. The removable insert 14B on the sides thereof abutting the covers 14A and 14B is not adhesively secured to each other and defines a fracture region.

In contrast, the removable insert 14B has a compressed fit with the adjacent interior covers during the gluing operation and the adhesion of this removable insert to the adhesive layer 110 is not particularly high. Thus, by removing this insert and then tearing adjacent perforation line 64, the individual sections are easily separated. Each section includes a cover either 14A or 14C which is positively secured to the outer cover via the adhesive layer 110. This allows an end user to easily separate the section of the manual which is relevant to the user and use only that section if so desired.

The securement of individual pages 100 and 102 that is typically the result of these pages being produced by web based printing provides challenges with respect to strong securement of these individual pages in the individual sections. The roughing step indicated at 24 assists in providing increased surface area and positive gripping of the individual pages.

The removable insert need not be the same size as the interior covers and could be a half width insert for example. Other variations are possible. The two interior covers separated by the removable insert provided, a weakening zone in the spine, particularly when the removable insert 14B is removed.

Although the separation of the individual sections is easily accomplished when the removable insert is separated, it has also been found that it is possible to separate the sections without removal of this insert. Basically, the insert has been found to provide a weakening zone that assists in the full separation. Obviously the removal of the insert also provides an exposed region of the adhesive where the tear of the adhesive generally occurs. The removable insert also facilitates proper directing of the adhesive to the inside of 14a and 14c (see FIG. 10).

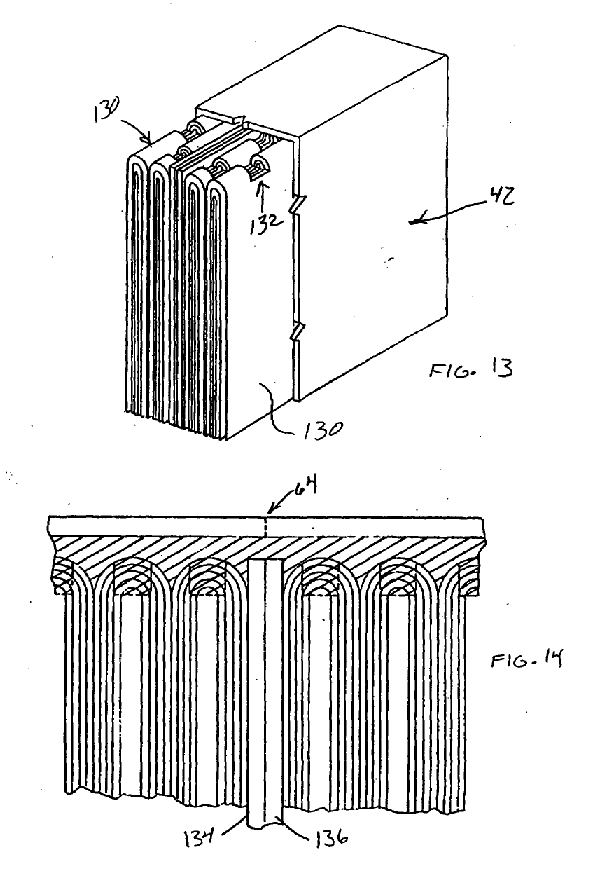

For high volume publications, it is many times more cost effective to produce the signatures that will form the pages of the publication on a web based system. These systems operate at high speed and are quite cost effective. For smaller runs, the individual sheets may be produced on a sheet fed system which produces notched signatures as indicated in FIG. 13. In this case, the signatures are not cut along what will become the adhesive edge as they have been notched along their length and glued.

The perforation of the outer covers 42 can be formed in many ways. For example, the covers can be perforated on a printing press during printing of the covers, as a separate step after printing of the covers (for example, on a folder),as a separate step after printing of the covers or as part of the binding process. Perforation is preferred but other approaches to weaken the covers to provide a tear line is possible, such as scoring.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A publication divided into at least two sections where each section comprises a first cover, a series of pages and a second cover; said publication between opposed covers of adjacent sections including a weakening member to assist in separation and removal of said sections one from the other; said series of pages, said covers and said weakening member being adhesively secured along a spine portion of said publication by a flexible tearable adhesive where the adhesive securement of any weakening member to said spine is of reduced strength relative to securement of said covers to said spine and forms a tear region along said spine between adjacent sections.

2. A publication as claimed in claim 1 wherein said publication has two sections.

3. A publication as claimed in claim 1 wherein said publication includes at least 3 sections.

4. A publication as claimed in claim 1 wherein each weakening member is a removable insert.

5. A publication as claimed in claim 4 wherein each weakening member is of a material similar to said covers.

6. A publication as claimed in claim 1 wherein said covers are of a heavier paper stock relative to said series of pages.

7. A publication as claimed in claim 6 wherein said series of pages are produced by web based printing.

8. A publication as claimed in claim 7 wherein said series of pages each include a non-notched edge adhesively secured to said spine.

9. A publication as claimed in claim 7 wherein said series of pages each include a generally straight adhesive receiving edge secured to said spine.

10. A publication as claimed in claim 9 wherein said covers are of cover stock having a gauge of about 7 pt or greater.

11. A publication as claimed in claim 10 wherein said series of pages are produced as web based signatures.

12. A publication as claimed in claim 11 said web based signatures are of about 45 lb coated stock.

13. A publication as claimed in claim 9 wherein series of pages along said generally straight adhesive receiving edge have been subjected to an operation to roughen said edge to improve adhesion.

14. A method of manufacturing a printed publication having at least two sections capable of being physically separated one from the other with said sections forming pairs of adjacent sections said method comprising
assembling a series of signatures in combination with at least one group of 2 interior covers and an intermediate removable insert where each group is located between and separates a pair of adjacent sections;
aligning said signatures and said groups by cutting at least said signatures along a cut edge to form cut pages and aligning said cut edge with a binding edge of said interior covers and removable insert;
applying a tearable glue to said aligned cut edge of said pages and said binding edge of said interior covers and removable insert; and
applying and adhesively securing an outer cover about said sections and across said cut edge and said binding edge.

15. A method as claimed in claim 14 including providing at least one tear region in said outer cover where each tear region is located between adjacent sections and aligned with said removable insert.

16. A method as claimed in claim 15 wherein each tear region is a perforation line provided in said outer cover prior to securement of said outer cover to said publication.

17. A method as claimed in claim 15 wherein said interior covers are of a paper stock similar to the paper stock of said outer cover.

18. A method as claimed in claim 17 wherein said signatures are produced by web printing on a coated paper web stock or offset stock.

19. A method as claimed in claim 15 wherein said step of adhesively securing said pages, said interior covers and removable insert and said outer cover includes using a hot melt adhesive.

20. A method as claimed in claim 19 including trimming said publication along edges thereof to form a finished publication.
